(19) United States
(12) Patent Application Publication
(10) Pub. No.: US 2007/0239538 A1
(43) Pub. Date: Oct. 11, 2007

(54) Incentivized relationship-data communication to select targeted content method and system

(76) Inventor: Raghavendra Misra, Jacksonville Beach, FL (US)

Correspondence Address: Raj Abhyanker, LLP;C/O PortfolioIP, P.O. Box 52050, Minneapolis, MN, 55402, US

(21) Appl. No.: 11/401,506

(22) Filed: Apr. 11, 2006

(51) Int. Cl. G06Q 30/00

(52) U.S. Cl. 705/14

(57) ABSTRACT

Incentivized relationship-data communication to select targeted content method and system is disclosed. In one embodiment, a method includes analyzing a context data describing at least one preference of a recipient to generate a content data in a communication between a sender module and a recipient module, and/or providing an incentive to a sender when the recipient responds to the content data. The incentive may be a financial disbursement to the sender when the recipient responds to the content data. The financial disbursement may be a portion of the payment of the content provider. The communication may be generated in a web-based communication system, a telecommunication system, an email client, and/or a corporate intranet. The context data may be a hobby data, a geographic data, an educational data, a family data, a culinary data, a health data, a travel data, a cultural data, and/or an epoch data.

### FIELD OF TECHNOLOGY

This disclosure relates generally to the technical fields of software and/or hardware technology and, in one example embodiment, to a method and/or a system of incentivized relationship-data communication to select targeted content.

### BACKGROUND

A targeted message (e.g., a communication having a content tailored to a recipient's preferences, demographics, location, education level, culture, political preference, etc.) can be used to increase a response probability of the recipient who receives the targeted message. A communication system (e.g., an email system) may be used to deliver the targeted message to the recipient (e.g., a potential buyer, an email recipient, a corporate affiliate, etc.) from a sender (e.g., an advertising agency, a email sender, a corporate employee, etc.).

For example, when a targeted communication system is the email system (e.g., Yahoo!®Mail, Google®GMail, a corporate Microsoft®Outlook® server, etc.) the email system may communicate a standard message to the recipient in the form of a banner ad, a link and/or a dynamic display, etc. that may be generic and/or not targeted specifically to the recipient's interests and/or preferences (e.g., educational, geographic, sporting, cultural and/or political interests and/or hobbies, pastimes etc.). In another example, the email system may deliver the targeted message by analyzing contents of emails received by the recipient (e.g., based on data extracted from a body of an email correspondence between the sender and the recipient).

The targeted communication system may utilize a computer algorithm to analyze content's of emails received by the recipient. The computer algorithm may not fully appreciate attributes (e.g., preferences, demographics, location, education level, culture, political preference, etc.) that may be relevant to the recipient. As such, the response probability of the targeted message may be lower than desired (e.g., because the recipient may not be attracted to advertising content that does not capture specific and/or personal preferences personally relevant to the recipient).

The targeted messaging system may communicate inappropriate, irrelevant, and/or erroneous versions of the targeted message to the recipient because of the computer algorithm (e.g., information extracted from an email body may be irrelevant and/or uncorrelated to the recipient). In addition, the targeted messaging system may be inefficient (e.g., the computer algorithm may be slow and/or complicated in analyzing data collected. The computer algorithm used to extract information from an email body may not be able to recognize and/or differentiate the most relevant content. In addition, the targeted messaging system may provide little incentive for the sender beyond basic email service.

### SUMMARY

Incentivized relationship-data communication to select targeted content method and system is disclosed. In one aspect, a method includes analyzing a context data describing at least one preference of a recipient to generate a content data in a communication between a sender module and a recipient module, and/or providing an incentive to a sender when the recipient responds to the content data. The incentive may be a financial disbursement to the sender and/or the recipient when the recipient responds to the content data and a successful transaction is verified by the delivery module and the content provider.

The financial disbursement may be a portion of the payment of the content provider. The communication may be generated in a web-based communication system, a telecommunication system, an email client, and/or a corporate intranet. The context data may be a hobby data, a geographic data, an educational data, a family data, a culinary data, a health data, a travel data, a cultural data, and/or an epoch data.

The method may also include automatically selecting the content data using a comparative algorithm that selects from a hierarchy of matching content when the sender composes an identifier of the recipient in the communication. The method may further include buffering hierarchies of matching content in the delivery module of each recipient associated with each sender, and/or generating the hierarchy of matching content based on a meta-data match between the content data and the context data. The meta-data match may be based on a neural network algorithm that associates various terms (e.g., similar and/or dissimilar) with each other based on a profile marketing data.

The sender may select what category of content data to display for each recipient. The categories of content data may include an advertisement data, a coupon data, a sweepstakes data, an educational data, a news data, a current event data, and/or a special interest data. The context data may be voluntarily provided to the delivery module by the sender module using a profile generator capturing preferences of various recipients associated with the sender, and/or may be provided by a relationship network describing attributes of various parties associated with the sender.

The method may further include processing a payment of a content provider associated with the content data when the recipient responds to the content data. Another payment of the content provider may be processed based on an impression count of the content data generated in communications between various senders and recipients. The method may further include enabling the sender module to respond the content data when not associated in a network communicatively coupled to the delivery module.

In another aspect, a method includes a delivery module analyzing a context data describing at least one preference of a recipient to generate a content data in a communication between a sender module and a recipient module, and/or processing a payment of the sender module based on a relationship between the sender module and the delivery module. The context data may include an organizational data, a functional-role data, a title data, and/or a seniority data. The relationship may be based on an impression count of the content data generated in communications to recipients. A particular offering in a catalog module may be provided as the content data based on the analyzing the context data.

In yet another aspect, a system includes a delivery module to analyze a context data describing at least one preference of a recipient, and/or any number of associated devices communicatively coupled to the delivery module to apply a targeted content data generated by the delivery module during communications between the associated devices. The delivery module may automatically select the targeted content data using a comparative algorithm that selects from a hierarchy of matching content when a sender composes an identifier of the recipient in the communication. The delivery module may buffer hierarchies of target content in the delivery module for each recipient associated with each sender, and/or generate the hierarchy of matching content based on a meta-data match between the target content data and the context data.

The methods, systems, and apparatuses disclosed herein may be implemented in any means for achieving various aspects, and may be executed in a form of a machine-readable medium embodying a set of instructions that, when executed by a machine, cause the machine to perform any of the operations disclosed herein. Other features will be apparent from the accompanying drawings and from the detailed description that follows.

### BRIEF DESCRIPTION OF THE DRAWINGS

Example embodiments are illustrated by way of example and not limitation in the figures of the accompanying drawings, in which like references indicate similar elements and in which:

FIG. 1 is a system view of a delivery module that communicates with an individual device, a group device, an organization device, a relationship network, and a content provider, according to one embodiment.

FIG. 2 is an exploded view of the delivery module of FIG. 1, having a preference module, a control module, a content module, a central database, and a transaction module, according to one embodiment.

FIG. 3 is a delivery table view of content referenced by the central database of FIG. 2, according to one embodiment.

FIG. 4 is a tracking table view of content referenced by the transaction database of the transaction module of FIG. 2, according to one embodiment.

FIG. 5 is an interaction diagram of a process flow between two or more individuals of FIG. 1, according to one embodiment.

FIG. 6 is an interaction diagram of a process flow between two or more organizations of FIG. 1, according to one embodiment.

FIG. 7 is an interaction diagram of a process flow between an individual and a group of FIG. 1, according to one embodiment

FIG. 8 is a diagrammatic representation of a machine in the form of a data processing system within which a set of instructions, for causing the machine to perform any one or more of the methodologies discussed herein, may be executed, according to one embodiment.

FIG. 9 is a process flow to analyze a context data describing at least one preference of a recipient individual to generate a content data in a communication between a sender module and a recipient module, according to one embodiment.

FIG. 10 is a process flow to process a payment of the sender module based on a relationship between the sender module and the delivery module, according to one embodiment.

Other features of the present embodiments will be apparent from the accompanying drawings and from the detailed description that follows.

### DETAILED DESCRIPTION

Incentivized relationship-data communication to select targeted content method and system is disclosed. In the following description, for the purposes of explanation, numerous specific details are set forth in order to provide a thorough understanding of the various embodiments. It will be evident, however to one skilled in the art that the various embodiments may be practiced without these specific details.

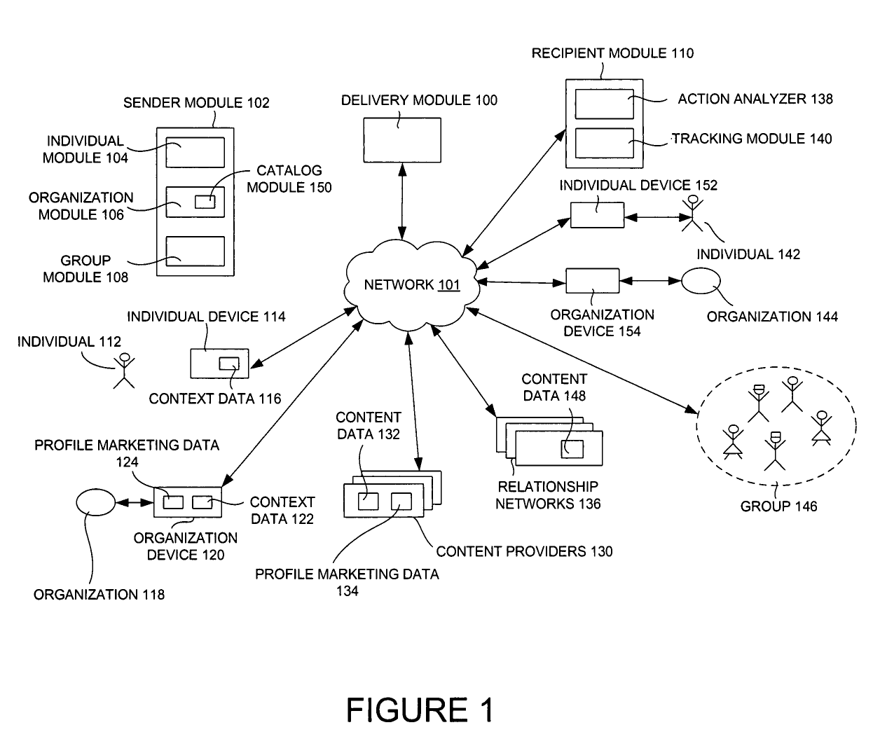

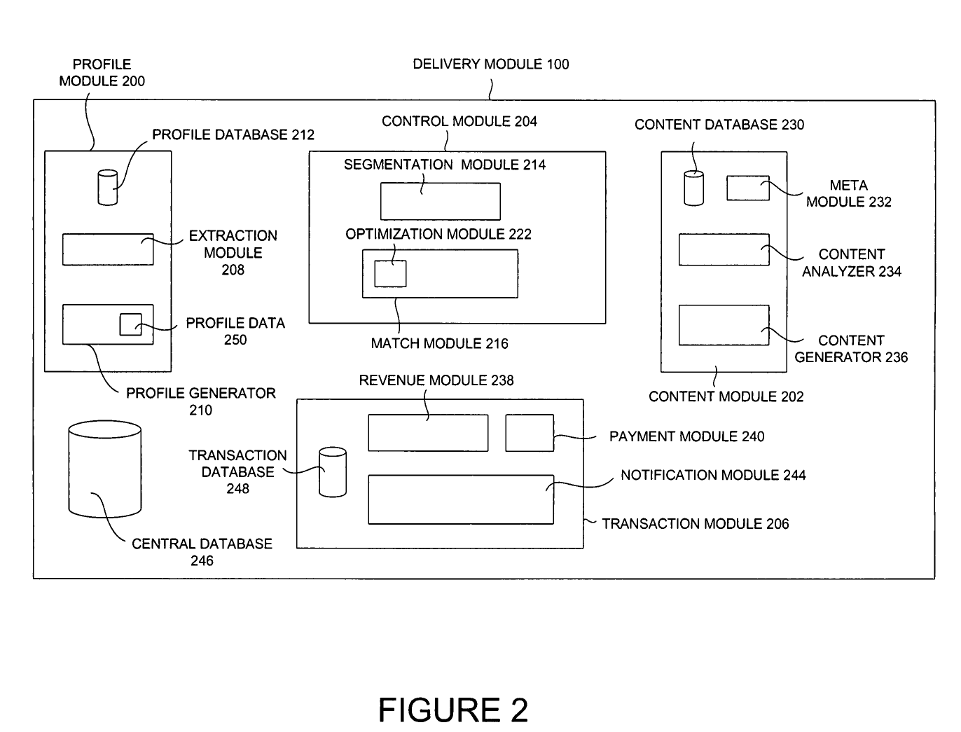

An example embodiment provides methods and systems to analyze a context data describing at least one preference (e.g., a context data 116 and/or a context data 122 of FIG. 1) of a recipient (e.g., a recipient individual 142, a recipient organization 144, and/or a recipient group 146 of FIG. 1) to generate a content data (e.g., using a content generator 236 of a content module 202 of FIG. 2) in a communication between a sender module (e.g., the sender module 102 of FIG. 1) and a recipient module (e.g., a recipient module 110 of FIG. 1), and/or provide an incentive (e.g., a financial disbursement) to a sender (e.g., a sender individual 112 and/or a sender organization 118 of FIG. 1) when the recipient responds to the content data.

Another example embodiment provides methods and systems to analyze a context data describing at least one preference of a recipient to generate a content data in a communication (e.g., a communication generated in a web-based communication system, a telecommunication system, an email client, and/or a corporate intranet) between a sender module and a recipient module, and/or process a payment of the sender module based on a relationship between the sender module 102 and the delivery module (e.g., the delivery module 100 of FIG. 1).

A further example embodiment provides methods and systems to analyze a context data 116 describing at least one preference of a recipient, and/or associated devices (e.g., an individual device 114 and/or an organization device 120 of FIG. 1) communicatively coupled to the delivery module 100 to apply a targeted content data generated by the delivery module 100 during communications between the associated devices.

It will be appreciated that the various embodiments discussed herein may/may not be the same embodiment, and may be grouped into various other embodiments not explicitly disclosed herein.

FIG. 1 is a system view of a delivery module 100 that communicates with a sender module 102, a recipient module 110, at least one individual device 114 (e.g., a PDA, laptop, desktop, etc. associated with a sender individual 112, as illustrated in FIG. 1), an organization device 120 (e.g., an organization device 120 associated with an organization 118, as illustrated in FIG. 1), a content provider 130, and a relationship network 136, according to one embodiment.

The sender module 102 may include an individual module 104, an organization module 106 and/or a group module 108. The individual module 104 may interact with an individual device 114 to communicate a context data 116 (e.g., a context data 116 may represent information about particular and/or common interests, hobbies, and/or characteristics of a recipient individual 142 and/or a recipient group 146 associated with and/or connected socially to the sender individual 112) to the delivery module 100. In one embodiment, the sender module 102 may respond to a content data when not associated in a network communicatively coupled to the delivery module 100.

The organization module 106 may interact with an organization device 120 associated with a sender organization 118 to communicate a profile marketing data 124 representing information about goods, services and/or offerings associated with the organization 118 that may be of interest and/or relevant to a recipient organization 144, to the delivery module 100. The organization module 118 may communicate a context data 122 containing information about interests, preferences and/or characteristics of the recipient organization 144 to the delivery module 100.

The group module 108 may communicate with the delivery module 100, the individual device 114 and/or the organization device 120 to process a communication to multiple recipients. The group module 108 may generate and/or process (e.g., using a matching algorithm) content targeted to various recipient profiles (e.g., the group module 108 may generate multiple unique communications each having content targeted to the preferences of the specific recipient, multiple similar communications having content targeted to a hierarchy of preferences and/or characteristics shared by the recipients, and/or content targeted to various grouping combinations).

The recipient module 110 may include a tracking module 140 and/or an action analyzer 138. The recipient module 110 may communicate with the delivery module 100 and/or the sender module 102 to process (e.g., monitor, analyze, track, and/or direct, etc.) a communication between the sender and the recipient(s) (e.g., a communication may be generated in a web-based communication system, a telecommunication system, an email client, and/or a corporate intranet, etc.).

The tracking module 140 may attach a meta-data tag and/or tracking mechanism to the communication and/or content data delivered to a recipient. In one embodiment, the action analyzer 138 may communicate with the delivery module 100 to provide an incentive (e.g., a financial disbursement equal to a portion of a payment processed of the content provider 130 associated with the content data attached to the communication by the sender) to the sender and/or the recipient(s) when the recipient(s) respond(s) to the content (e.g., based on an impression count and/or click-through action etc. monitored by the tracking module 140) and a successful transaction is verified by the delivery module 100 and the content provider 130.

The recipient module 110 may communicate with the delivery module 100 to process another payment of the content provider 130 (e.g., based on an impression count of the content data generated in communications between various senders and recipients). In another embodiment, the recipient module 110 may communicate with the delivery module 100 to process a payment of the sender (e.g., based on a relationship between the delivery module 100 and the sender module 102).

The delivery module 100 may extract and/or receive a context data 148 associated with interests, preferences, and/or contextual information for any number of recipients from the relationship network 136 (e.g., a hobby data, a geographic data, an educational data, a family data, a culinary data, a health data, a travel data, a cultural data, an entertainment data, and/or an epoch data, etc.). The relationship network 136 may include virtual friendship and/or business networks, interest and/or service groups, and/or social directories having access to information pertaining to the interests and/or preferences of various member entities (e.g., Facebook®, MySpace®, Plaxo®, LinkedIn®, etc.).

In one embodiment, the delivery module 100 may communicate with the content provider 130 (e.g., a content provider 130 may include an organization, company, social network and/or institution) to capture and/or process a content data 132 related to particular goods, services, information and/or offerings associated with the content provider 130. The content provider 130 may communicate various content data 132 categories (e.g., an advertisement data, a coupon data, a promotions data, a sweepstakes data, an educational data, a news data, a trivia data, current event data, and/or a special interest data) to the delivery module 100 for the sender to process a selection of content data to be displayed in the communication). In another embodiment, the delivery module 100 may generate a content data 132 based on a meta-data match between the context data and a profile marketing data 134 communicated by the content provider 130.

In one embodiment, the delivery module 100 may interact with the individual module 104 of the sender module 102, the recipient module 110, the content provider 130, and/or the relationship network 136 to capture and/or analyze a context data 116 and/or generate a targeted content data (e.g., content targeted to preferences and/or interests of a recipient) in a communication (e.g., email message, Short Message Service (SMS), Multimedia Messaging Service (MMS), etc.) between the sender module 102 and the recipient module 110 (e.g., between a sender individual 112 and a recipient individual 142 and/or a recipient group 146). The delivery module 100 may select the content data using a comparative algorithm that selects from a hierarchy of matching content (e.g., a hierarchy of matching content generated based on neural network algorithm processing a meta-data match between the context data and a content data communicated by a content provider 130) when a sender composes an identifier of a recipient in the communication. The delivery module 100 may buffer hierarchies of matching content in the delivery module for each recipient associated with each sender.

In another embodiment, the delivery module 100 may interact with the organization module 106 of the sender module 102, the recipient module 110, and/or the relationship network 136 to capture and/or analyze a context data 122 (e.g., an organizational data, a functional-role data, a title data, and/or a seniority data, etc.) and/or generate the targeted content data in a communication between the sender module 102 and the recipient module 110 (e.g., between a sender organization 118 and a recipient organization 144). The delivery module 100 may select the content data (e.g., from a particular offering in the catalog module 150 of the organization module 106) based on an analysis of the context data using a comparative algorithm that selects from a hierarchy of matching content (e.g., the delivery module 100 may buffer hierarchies of matching content for each recipient associated with each sender) when a sender composes an identifier of a recipient in the communication.

FIG. 2 is an exploded view of the delivery module 100 of FIG. 1, having a profile module 200, a control module 204, a content module 202, a central database 246, and a transaction module 206, according to one embodiment. The profile module 200 may include a profile database 212, an extraction module 208, and/or a profile generator 210.

The profile module 200 may include an extraction module 208, a profile generator 210, and/or a profile database 212. The extraction module 208 may interact with the profile generator 210 and/or the profile database 212 of FIG. 2, and/or the sender module 102 and/or the relationship network 136 of FIG. 1, to capture, extract and/or deliver profile information (e.g., information supplementary and/or complementary to the context data 116 and/or the context data 122 of FIG. 1, related to preferences, interests and/or characteristics associated with the recipient) to the profile generator 210.

The profile generator 210 may interact with the sender module 102 and/or the recipient module 110 of FIG. 1, and/or the profile database 212, the extraction module 208, the control module 204, the content module 202 and/or the transaction module 206 of FIG. 2 to process (e.g., capture, store and/or generate, etc.) and/or communicate the profile information associated with the recipient to the control module 204.

The profile database 212 may store and/or reference historical, contemporary and/or dynamic data associated with the context and/or profile data of recipients (e.g., information related to the preferences, interests and/or characteristics of the recipients associated with a particular sender).

The control module 204 may include a segmentation module 214 and/or a match module 216. The match module 216 may include an optimization module 222. The segmentation module 214 may process a communication by the sender (e.g., analyze, sort, categorize and/or prioritize a protocol associated with the communication, etc.) to negotiate a process path (e.g., a sequential order of processing operations and/or communication queries) with the sender module 102 and/or the recipient module 110 of FIG. 1, and/or the profile module 200, the content module 202 and/or the transaction module 206 of FIG. 2. The match module 216 may coordinate processing (e.g., synchronize, compare, analyze and/or modify, etc.) of profile data communicated by the profile module 200 and/or relevant content data communicated by the content module 202 (e.g., through multiple serial and/or parallel operations and/or communications). The optimization module may leverage historical data associated with a particular recipient profile and/or process (e.g., generate, buffer and/or modify, etc.) a hierarchy of matching content associated with a communication to optimize the relevance of content data (e.g. content data generated by the content module 202) to the profile of the recipient.

The content module 202 may include a meta module 232, a content analyzer 234, a content generator 236, and/or a content database 230. The meta module 232 may communicate with the profile module 200 and/or the control module 204 of FIG. 2, and/or the sender module 102, the recipient module 110, the content provider 130 and/or the relationship network 136 of FIG. 1 to process (e.g., using a neural network algorithm) a meta-data match between the profile data communicated by the profile module 200 and/or the profile marketing data communicated by the sender module 102 and/or the content provider 130. The content analyzer 234 may communicate with the meta module 232, the content database 230, the content generator 236, the profile module 200 and/or the control module 204 of FIG. 2, and/or the sender module 102, the recipient module 110, the content provider 130 and/or the relationship network 136 of FIG. 1 to analyze (e.g., using a comparative algorithm) a hierarchy of matching and/or relevant content data when the sender enters an identifier of the recipient in a communication.

The content generator 236 may interact with the meta module 232, the content database 230, the content analyzer 234, the profile module 200 and/or the control module 204 of FIG. 2, and/or the sender module 102, the recipient module 110, the content provider 130 and/or the relationship network 136 of FIG. 1 to generate a targeted content in a communication between the sender and the recipient(s). The content database 230 may store and/or reference historical, contemporary and/or dynamic content data (e.g., the profile marketing data 134 illustrated in FIG. 1) associated with various content providers 130 and/or organizations 118 (e.g., information related to goods, services, offerings and/or information associated with a particular organization 118 and/or content provider 130).

The transaction module 206 may include a revenue module 238, a payment module 240, and/or a notification module 244. The revenue module 238 may communicate with the tracking module 140 of FIG. 1 to capture, track, monitor and/or record a revenue flow and/or series of transactions (e.g., the revenue flow may accrue from payments receivable of the content provider 130 of FIG. 1 based on a cumulative history of recipients' responses (e.g., click-throughs, page hits, etc.) to content data associated with the content provider 130 in various communications, further payments receivable of the content provider 130 based on impression counts of the content data associated with the content provider 130 generated in communications between various senders and recipients, and/or payments receivable of an organization 118 of FIG. 1 based on a relationship between the organization 118 and the delivery module 100, etc.)

The payment module 240 may communicate with the revenue module 238 an/or the tracking module 140 of FIG. 1 to process an incentive (e.g., a financial disbursement) to the sender when the recipient responds to the content data in a communication by the sender, based on a relationship between the sender and the delivery module 100 (e.g., the incentive may be a portion of the payment of the content provider).

The payment module 240 may process a payment of the content provider 130 (e.g., a revenue amount receivable communicated by the tracking module 140) based on recipients' responses (e.g., click-throughs, page hits, etc.) to content data associated with the content provider 130 in various communications. The payment module 240 may process another payment of the content provider 130 based on an impression count of the content data associated with the content provider 130 generated in communications between various senders and recipients.

The notification module 244 may interact with the revenue module 238, the payment module 240 and/or the tracking module 140 of FIG. 1 to process communications to various parties (e.g., to the sender individuals 112, the sender organizations 118 and/or the content providers 130 of FIG. 1). The communications may include information associated with and/or relevant to the various parties. For example, the notification module 244 may communicate a report of revenue generated (e.g., revenue generated per content item and/or per recipient) to the individual sender 112 of FIG. 1, and/or a report of charges incurred and/or statistics (e.g., cost-per-thousand impressions, cost-per click, recipient response statistics and/or traffic logs, profile marketing meta-data and/or statistics) to the sender organization 118 and/or the content provider 130 of FIG. 1.

For example, an individual ‘John’ may use an incentivized relationship-data communication system called ‘Atmani™’ to send an email to another individual ‘Mary.’ John and Mary may happen to know each other personally and/or socially (e.g., John and Mary may be family, friends, co-workers, and/or acquaintances, etc.). John may therefore happen to know that Mary has certain personal preferences and/or interests. For example, John may know that Mary enjoys tennis, That food and classical music. John may keep a record of Mary's interests (e.g., as additional data associated with Mary's contact information stored in an email application such as Outlook®).

John may open his Outlook® application and select an option to send a new email message. As John begins to type Mary's email address, ‘Atmani™’ may synchronize with John's Outlook® and automatically search for a history of additional information associated with the email recipient ‘Mary.’ If John has no information about Mary stored in Outlook®, ‘Atmani™’ may extract information associated with Mary from a relationship network (e.g., MySpace®, Plaxo®, Facebook®, etc.) in which Mary maintains a profile. When ‘Atmani™’ has identified Mary's interests, it may compare these interests with a profile of data from a content provider and select certain content to be attached to John's email to Mary.

For example, the content attached by ‘Atmani™’ may be an ad by King Siam That Restaurant in San Jose, Calif., a promotional offer for reduced-price tickets to a San Francisco Symphony Orchestra performance, and a table of results from a recent Wimbledon tennis tournament, because Atmani™ may determine that the content is the best match for Mary's preferences and is the most likely to attract Mary's interest if attached to the email. King Siam That Restaurant and San Francisco Symphony Orchestra may provide a consideration to Atmani™ in exchange for attaching their content to John's email. The Wimbledon results may be downloaded by Atmani™ from a free online resource.

When Mary receives the email, she may click on the King Siam ad and/or the San Francisco Symphony Orchestra offer because she is interested in That food and classical music. She may also view the Wimbledon results. Atmani™ may track Mary's response to the content in the email, and remit a portion of the consideration provided by King Siam That Restaurant and San Francisco Symphony Orchestra to John.

In another example, Bubba Hardware may be a hardware firm using Atmani™ to send an email to Gump Builders, a construction company. Bubba Hardware may provide a consideration to Atmani™ for maintaining a profile containing information about particular catalog offerings Bubba Hardware may wish to provide to various parties (e.g., business partners), as well as information associated with the parties (e.g., Gump Builders). When an employee of Bubba Hardware enters a name of a recipient while composing an email to Gump Builders, Atmani™ may determine that a particular feature in a catalog offering by Bubba Hardware matches the interests of a particular department of Gump Builders. For example, Atmani™ may determine that Gump Builders is based in Lafayette, La., and attach content informing the purchasing department of Gump Builders that Bubba Hardware is currently able to provide guaranteed bulk-quantity supplies of a particular model of 2-inch galvanized steel nails to any location in Louisiana.

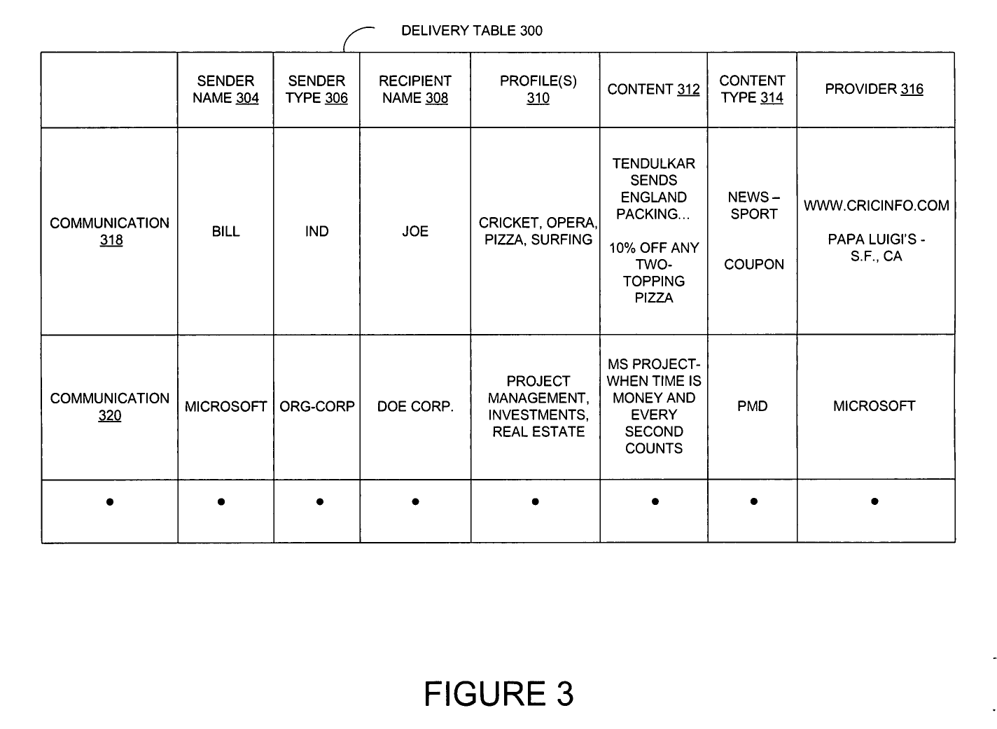

FIG. 3 is a delivery table view 302 of content referenced by the central database of FIG. 2, according to one embodiment. The delivery table view 302 may include a communication 318 and/or a communication 320 (e.g., displaying various fields referencing data associated with the communication 318 and/or the communication 320 between a sender and a recipient), a sender name field 304, a sender type field 306, a recipient name field 308, a profile(s) field 310, a content field 312, a content type field 314 and/or a provider field 316. The sender name field 304 may reference an identifier associated with the sender (e.g., a name, index number, and/or a file reference number, etc.). The sender type field 306 may reference a category and/or subcategory associated with the sender (e.g., the individual 112, and/or the organization 118 illustrated in FIG. 1).

The recipient name field 308 may reference an identifier associated with the recipient of the communication 318 (e.g., a name, an index number, and/or a file reference number, etc.) The profile(s) field 310 may reference context data (e.g., preferences, interests and/or characteristics communicated and/or processed by the profile module 200 of FIG. 2) associated with the recipient of the communication 318. The content field 312 may reference a content data (e.g., a content data communicated and/or processed by the content module 202 of FIG. 2) associated with a particular content provider (e.g., the content provider 130 of FIG. 1) and/or an organization (e.g., the organization 118 of FIG. 1), and/or targeted to the profile and/or context data (e.g., the context data referenced by the profile(s) field 310) associated with the recipient of the communication 318. The content type field 314 may reference a category identifier associated with the content data generated in the communication 318. The provider field 316 may reference an identifier for the content provider associated with the content data generated in the communication 318.

For example, two hypothetical delivery table views 302 (e.g., communication 318 and communication 320 are illustrated. In an example communication 318, the sender name field 304 displays ‘Bill,’ indicating an identifier associated with the name of the sender of communication 318. The sender type field 306 displays ‘IND,’ indicating that ‘Bill’ is an individual. The recipient name field 308 displays ‘Joe,’ indicating an identifier associated with the name of the recipient of communication 318. The profile field 310 displays ‘Cricket, Opera, Pizza, Surfing,’ referencing various interests and/or preferences specific to recipient ‘Joe.’ The content field 312 displays ‘Tendulkar sends England packing . . . ’ and ‘10% off any 2-topping pizza!,’ referencing the content attached to the communication 318 between sender ‘Bill’ and recipient ‘Joe.’

The content type field 314 displays ‘News—Sport’ and ‘Coupon,’ indicating that ‘Tendulkar sends England packing . . . ’ is of the content type ‘News-Sport,’ and ‘10% off any 2-topping pizza!’ is off the content type ‘Coupon.’ The provider field 316 displays ‘www.Cricinfo.com’ and ‘Papa Luigi's —S.F., CA,’ indicating that the content “Tendulkar sends England packing . . . ’ attached to the communication 318 between sender ‘Bill’ and recipient ‘Joe’ is provided by the content provider ‘www.Cricinfo.com,’ and the content ‘10% off any 2-topping pizza!’ also attached to the communication 318 between sender ‘Bill’ and recipient ‘Joe’ is provided by the content provider ‘Papa Luigi's—S.F., CA.’

In an example communication 320, the sender name field 304 displays ‘Microsoft,’ indicating an identifier associated with the name of the sender of communication 320. The sender type field 306 displays ‘Org-Corp,’ indicating that ‘Microsoft’ is a corporate organization. The recipient name field 308 displays ‘Doe Corp.,’ indicating an identifier associated with the name of the recipient of communication 320. The profile field 310 displays ‘Project Management, Investments, Real Estate,’ referencing various profile interests and/or characteristics specific to recipient ‘Doe Corp.’ The content field 312 displays ‘MS Project—When Time is Money and Every Second Counts,’ referencing the content attached to the communication 320 between sender ‘Microsoft’ and recipient ‘Doe Corp.’ The content type field 314 displays ‘PMD’ indicating that ‘MS Project—When Time is Money and Every Second Counts’ is of the content type ‘PMD’ (e.g., the profile marketing data 124 of FIG. 1). The provider field 316 displays ‘Microsoft,’ indicating that the content ‘MS Project—When Time is Money and Every Second Counts’ attached to the communication 320 between sender ‘Microsoft’ and recipient ‘Doe Corp.’ is provided by the organization ‘Microsoft.’

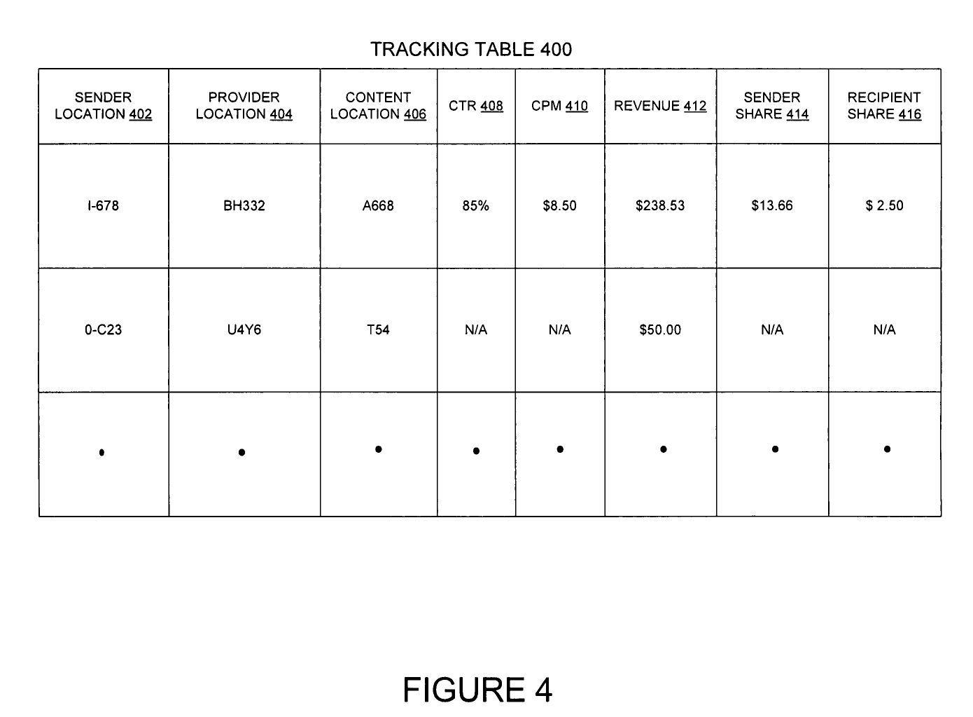

FIG. 4 is a tracking table view 400 of content referenced by the transaction database 248 of the transaction module 206 of FIG. 2, according to one embodiment. The tracking table view 400 may include a sender location field 402, a provider location field 404, content location field 406, a CTR (e.g., Click-Through Rate) field 408, a CPM (e.g., Cost Per Thousand impressions) field 410, a revenue field 412, a sender share field 414, and/or a recipient share 416. The sender location field 402 may display an identifier referencing a location in the transaction database 248 of transaction data associated with a particular sender. The provider location field 404 may display an identifier referencing locations in the transaction database 248 of transaction data associated with content providers who own a content data (e.g., the content data communicated by the content module 202 of FIG. 2 to the delivery module 100 of FIG. 1) generated in communications by the sender (e.g., the sender referenced in the sender location field 402).

The content location field 406 may display an identifier referencing the location in the transaction database 248 of transaction data associated with the content data generated in a communication by the sender. The CTR field 408 may display a statistic (e.g., a percentage figure) indicating a rate and/or level of recipient response and/or activity associated with the content data generated in a communication by the sender (e.g., the CTR statistic may be communicated to the content provider 130 of FIG. 1 by the notification module 244 of FIG. 2). The CPM field 410 may display an statistic indicating a measure of a cost to the content provider 130 of FIG. 1 relative to a number of impressions of the content data and/or a fixed number of units of recipient response and/or activity associated with the content data.

The revenue field 412 may display a currency figure indicating the revenue generated (e.g., payments receivable of the content provider when the recipient responds to the content data, payments receivable of an organization 118 based on a relationship between the delivery module 100 and/or the sender module 102 of FIG. 1, and/or payments receivable of the content provider 130 based on an impressions count of the content data generated in communications between various senders and recipients). The sender share field 414 may display a currency figure indicating a portion of the revenue amount referenced in the revenue field 412 that is payable to the sender referenced in the sender location field 402. The recipient share field 416 may display a currency figure indicating a portion of the revenue amount referenced in the revenue field 412 that is payable to a recipient associated with the sender.

For example, two hypothetical tracking table views are illustrated. The sender location field 402 displays ‘I-678’ and ‘O-C23,’ indicating identifiers and/or locations in the transaction database 248 for transaction data associated with the senders. The provider location field 404 displays ‘BH332’ and ‘U4Y6,’ indicating identifiers and/or locations in the transaction database 248 for transaction data associated with the providers. The content location field 406 displays ‘A668’ and ‘T54,’ indicating identifiers and/or locations in the transaction database 248 for transaction data referencing content associated with the senders and providers. For example, the content having location ‘A668’ may be provided by the content provider having location ‘BH332’ and attached to a communication by the sender having location ‘I-678,’ and the content having location ‘T54’ may be provided by the content provider having location ‘U4Y6’ and attached to a communication by the sender having location ‘O-C23.’

The CTR field 408 displays ‘85%’ and ‘N/A,’ indicating that the click-through rate of recipient response to the content having location ‘A668’ is ‘85%,’ and the click-through rate of recipient response to the content having location ‘T54’ is ‘ N/A,’ (e.g., not applicable). The CPM field 410 displays ‘$8.50’ and ‘N/A,’ indicating that the cost-per-thousand-impressions to the content provider having location ‘BH332’ for the content having location ‘A668’ is ‘ $8.50’ and the cost-per-thousand-impressions to the content provider having location ‘U4Y6’ for the content having location ‘T54’ is ‘ N/A,’ (e.g., not applicable).

The revenue field 412 displays ‘$238.53,’ and ‘$50.00,’ indicating that the total revenue generated by the content having location ‘A668’ and attached to communications by the sender having location ‘I-678’ is ‘ $238.53,’ and the total revenue generated by the content having location ‘T54’ and attached to communications by the sender having location ‘O-C23’ is ‘$50.00.’ The sender share field 414 displays ‘$13.66’ and ‘N/A,’ indicating that ‘$13.66’ is a share of the revenue amount ‘$238.53’ that is payable to the sender having location ‘I-678,’ and that the sender having location ‘O-C23’ is not eligible for a share of the revenue amount ‘$50.00.’ The recipient share field 416 displays ‘$2.50’ and ‘N/A,’ indicating that ‘$2.50’ is a share of the revenue amount ‘$238.53’ that is payable to the recipient associated with the sender having location ‘I-678,’ and that the recipient associated with the sender having location ‘O-C23’ is not eligible for a share of the revenue amount ‘$50.00.’

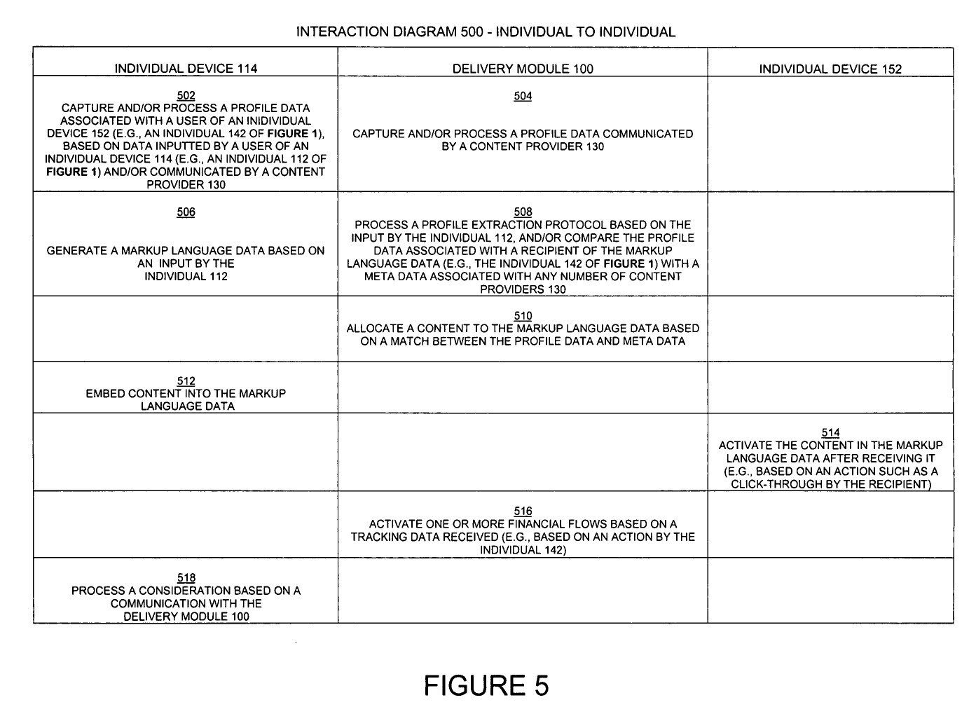

FIG. 5 is an interaction diagram of a process flow between an individual device 114, a delivery module 100, and an individual device 152 of FIG. 1, according to one embodiment. In operation 502, a profile data associated with a user of an individual device 152 (e.g., an individual 142 of FIG. 1) is captured and/or processed by the individual device 114, based on data inputted by a user of an individual device 114 (e.g., an individual 112 of FIG. 1) and/or communicated by a content provider (e.g., a content provider 130 of FIG. 1). In operation 504 (e.g., a parallel operation), a profile data communicated by a content provider 130 is captured and/or processed (e.g., by the delivery module 100 of FIG. 1).

In operation 506, a markup language data is generated by the individual device 114 based on an input by the individual 112. In operation 508 (e.g., a parallel operation), a profile extraction protocol is processed by the delivery module 100 based on input by the individual 112, and/or a profile data associated with a recipient of the markup language data is compared with a meta data associated with any number of content providers (e.g., content providers 130 of FIG. 1) by the delivery module 100. In operation 510, a content (e.g., a content targeted to the interests, preferences and/or characteristics of the recipient) is allocated to the markup language data by the delivery module 100 based on a match between the profile data and meta data.

In operation 512, content is embedded into the markup language data by the individual device 114. In operation 514, the content in the markup language data is activated by the individual device 152 after receiving it (e.g., based on an action such as a click-through by the recipient). In operation 516, one or more financial flows are activated by the delivery module 100 based on a tracking data (e.g., a tracking data generated by the tracking module 140 of the recipient module 110 of FIG. 1) received based on an action by the user of individual device 152. In operation 518, a consideration is processed by the individual device 114 based on a communication with the delivery module 100.

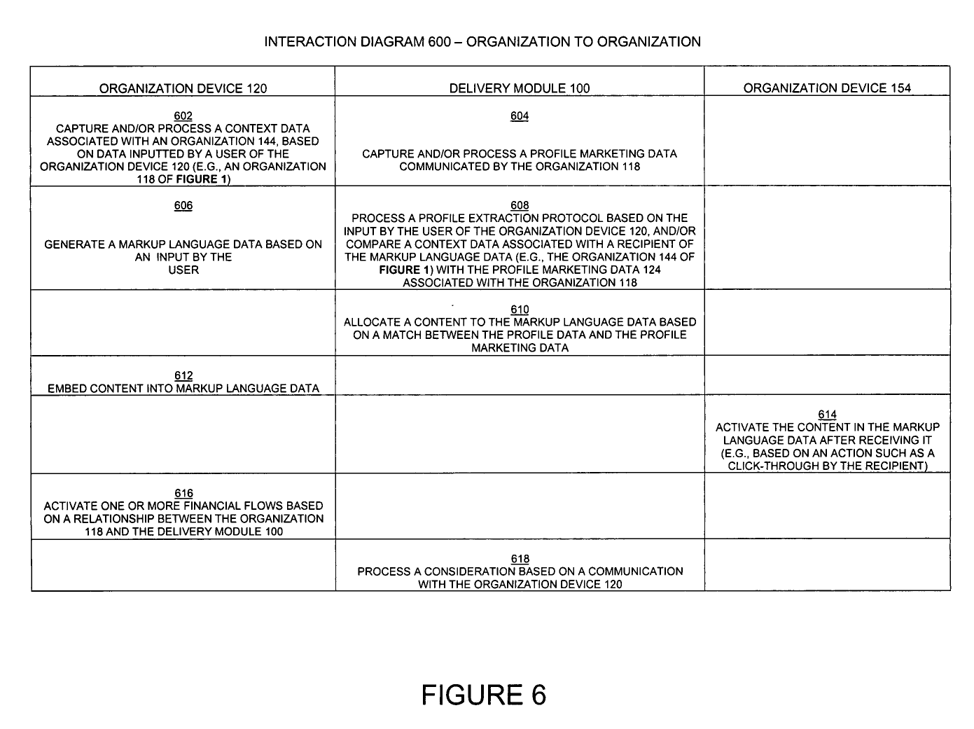

FIG. 6 is an interaction diagram of a process flow between an organization device 120, a delivery module 100 and an organization device 154 of FIG. 1, according to one embodiment. In operation 602, a context data associated with an organization 144 is captured and/or processed by the organization device 120, based on data inputted by a user of the organization device 120. In operation 604 (e.g., a parallel operation), a profile marketing data (e.g., a profile marketing data 124 of FIG. 1) communicated by the organization 118 is captured and/or processed (e.g., by the delivery module 100 of FIG. 1). In operation 606, a markup language data is generated by the organization device 120 based on an input by the user. In operation 608 (e.g., a parallel operation), a profile extraction protocol is processed by the delivery module 100 based on input by a user of the organization device 120, and/or a context data (e.g., an organizational data, a functional-role data, a title data, and/or a seniority data) associated with a recipient of the markup language data is compared with the profile marketing data 124 associated with the organization 118 by the delivery module 100.

In operation 610, a content is allocated to the markup language data by the delivery module 100 based on a match between the context data and the profile marketing data. In operation 612, content is embedded into the markup language data by the organization device 120. In operation 614, the content in the markup language data is activated by the organization device 154 after receiving it (e.g., based on an impression of the content and/or a click-through by the user of organization device 154). In operation 616, one or more financial flows are activated by the organization device 120 based on a relationship between the organization 118 and the delivery module 100. In operation 618, a consideration is processed by the delivery module 100 based on communication with the organization device 120.

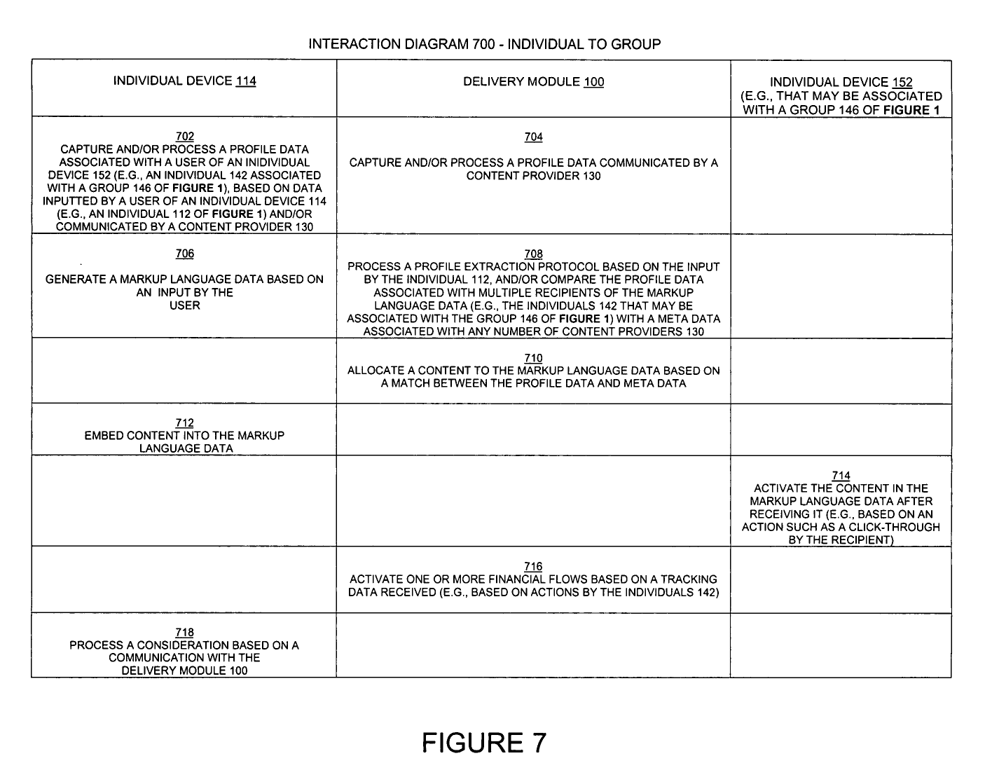

FIG. 7 is an interaction diagram of a process flow between an individual device 114, a delivery module 100 and multiple individual devices associated with a group 146 of FIG. 1, according to one embodiment. In operation 702, a profile data associated with users of individual devices 152 that may be associated with a group 146 is captured and/or processed by the individual device 114, based on data inputted by the user of individual device 114 (e.g., an individual 112 of FIG. 1) and/or communicated by a content provider (e.g., a content provider 130 of FIG. 1). In operation 704 (e.g., a parallel operation), a profile data communicated by a content provider 130 is captured and/or processed (e.g., by the delivery module 100 of FIG. 1). In operation 706, a markup language data is generated by the individual device 114 based on an input by the user.

In operation 708 (e.g., a parallel operation), a profile extraction protocol is processed by the delivery module 100 based on the input by the individual 112, and/or a profile data associated with multiple recipients of the markup language data is compared with a meta data associated with any number of content providers (e.g., content providers 130 of FIG. 1) by the delivery module 100. In operation 710, a content (e.g., a content targeted to the interests, preferences and/or characteristics of multiple recipients) is allocated to the markup language data by the delivery module 100 based on a match between the profile data and the meta data (e.g., using algorithms to generate multiple contents, each content being unique to a particular recipient, and/or using grouping, matching and/or neural network algorithms to generate a generic content targeted to a hierarchy of profiles common to the multiple recipients, etc.).

In operation 712, content is embedded into the markup language data by the individual device 114. In operation 714, the content in the markup language data is activated by the individual device 152 that may be associated with a group 146 after receiving it (e.g., based on an action such as a click-through by users of individual devices 152). In operation 716, one or more financial flows are activated by the delivery module 100 based on a tracking data (e.g., a tracking data generated by the tracking module 140 of the recipient module 110 of FIG. 1) received based on actions by users of individual devices 152 associated with the group 146. In operation 718, a consideration is processed by the individual device 114 based on a communication with the delivery module 100.

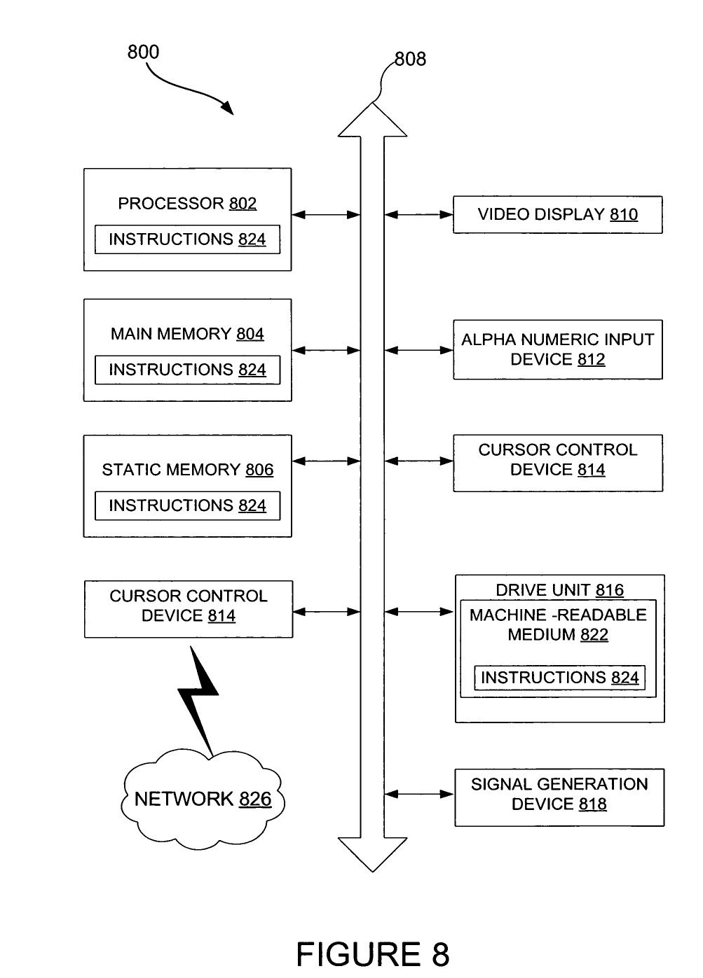

FIG. 8 is a diagrammatic representation of a machine in the form of a data processing system 800 within which a set of instructions, for causing the machine to perform any one or more of the methodologies discussed herein, may be executed. In various embodiments, the machine operates as a standalone device and/or may be connected (e.g., networked) to other machines. In a networked deployment, the machine may operate in the capacity of a server and/or a client machine in server-client network environment, and/or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch and/or bridge, an embedded system and/or any machine capable of executing a set of instructions (sequential and/or otherwise) that specify actions to be taken by that machine. Further, while only a single machine is illustrated, the term “machine” shall also be taken to include any collection of machines that individually and/or jointly execute a set (or multiple sets) of instructions to perform any one and/or more of the methodologies discussed herein.

The example computer system 800 includes a processor 802 (e.g., a central processing unit (CPU) a graphics processing unit (GPU) and/or both), a main memory 804 and a static memory 806, which communicate with each other via a bus 808. The computer system 800 may further include a video display unit 810 (e.g., a liquid crystal display (LCD) and/or a cathode ray tube (CRT)). The computer system 800 also includes an alphanumeric input device 812 (e.g., a keyboard), a cursor control device 814 (e.g., a mouse), a disk drive unit 816, a signal generation device 818 (e.g., a speaker) and a network interface device 820.

The disk drive unit 816 includes a machine-readable medium 822 on which is stored one or more sets of instructions (e.g., software 824) embodying any one or more of the methodologies and/or functions described herein. The software 824 may also reside, completely and/or at least partially, within the main memory 804 and/or within the processor 802 during execution thereof by the computer system 800, the main memory 804 and the processor 802 also constituting machine-readable media.

The software 824 may further be transmitted and/or received over a network 826 via the network interface device 820. While the machine-readable medium 822 is shown in an example embodiment to be a single medium, the term “machine-readable medium” should be taken to include a single medium and/or multiple media (e.g., a centralized and/or distributed database, and/or associated caches and servers) that store the one or more sets of instructions. The term “machine-readable medium” shall also be taken to include any medium that is capable of storing, encoding and/or carrying a set of instructions for execution by the machine and that cause the machine to perform any one or more of the methodologies of the various embodiments. The term “machine-readable medium” shall accordingly be taken to include, but not be limited to, solid-state memories, optical and magnetic media, and carrier wave signals.

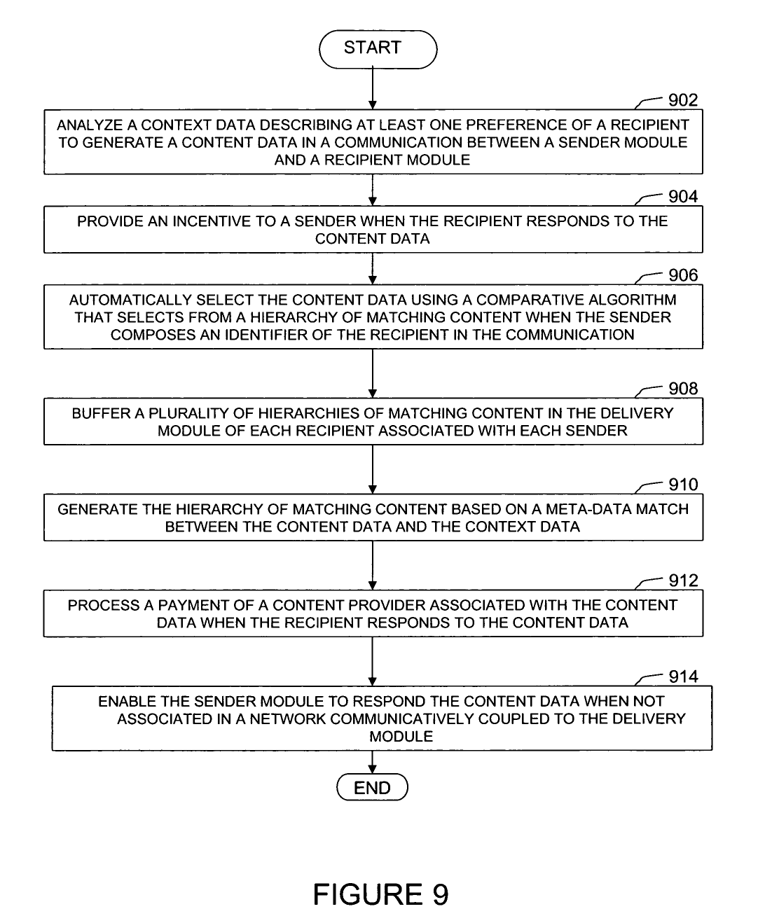

FIG. 9 is a process flow to analyze a context data describing at least one preference of a recipient (e.g., the individual 142 of FIG. 1) to generate a content data in a communication (e.g., a communication between an individual 112 and an individual 142 of FIG. 1) between a sender module (e.g., the sender module 102 of FIG. 1) and a recipient module (e.g., the recipient module 110 of FIG. 1), according to one embodiment. In operation 902, a context data (e.g., the context data 116 of FIG. 1) is analyzed describing at least one preference of a recipient to generate a content data in a communication between a sender module and a recipient module. In operation 904, an incentive to a sender (e.g., a financial disbursement) is provided (e.g., using the payment module 240 of FIG. 2) when the recipient responds to the content data.

In operation 906, the content data is automatically selected using a comparative algorithm that selects from a hierarchy of matching content when the sender composes an identifier of the recipient in the communication. In operation 908, a plurality of hierarchies of matching content is buffered in the delivery module (e.g., the delivery module 100 of FIG. 1) of each recipient associated with each sender. In operation 910, the hierarchy of matching content is generated based on a meta-data match between the content data and the context data. In operation 912, a payment is processed of a content provider associated with the content data when the recipient responds to the content data. In operation 914, the sender module is enabled to respond the content data when not associated in a network communicatively coupled to the delivery module.

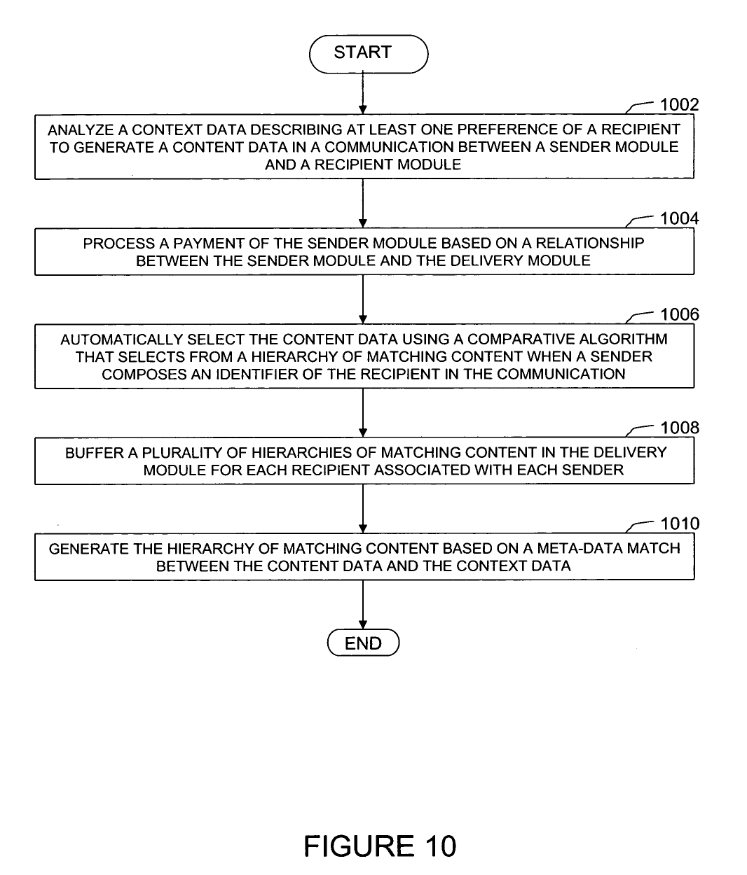

FIG. 10 is a process flow to analyze a context data describing at least one preference of a recipient (e.g., the recipient organization 144 of FIG. 1) to generate a content data in a communication between a sender module (e.g., the sender module 102 of FIG. 1) and a recipient module (e.g., the recipient module 110 of FIG. 1, according to one embodiment. In operation 1002, a context data (e.g., a context data 122) is analyzed describing at least one preference of a recipient to generate a content data in a communication between a sender module and a recipient module. In operation 1004, a payment is processed of the sender module based on a relationship between the sender module and the delivery module. In operation 1006, the content data is automatically selected using a comparative algorithm that selects from a hierarchy of matching content when a sender composes an identifier of the recipient in the communication. In operation 1008, a plurality of hierarchies of matching content is buffered in the delivery module (e.g., the delivery module 100 of FIG. 1) for each recipient associated with each sender. In operation 1010, the hierarchy of matching content is generated based on a meta-data match between the content data and the context data.

Although the present embodiments have been described with reference to specific example embodiments, it will be evident that various modifications and changes may be made to these embodiments without departing from the broader spirit and scope of the various embodiments. For example, the various devices, modules, analyzers, generators, etc. described herein may be enabled and operated using hardware circuitry (e.g., CMOS based logic circuitry), firmware, software and/or any combination of hardware, firmware, and/or software (e.g., embodied in a machine readable medium).

For example, the delivery module 100, the sender module 102, the individual module 104, the organization module 106, the group module 108, the recipient module 110, the individual device 114, the organization device 120, the action analyzer 138, the tracking module 140, the catalog module 150, the individual device 152, the organization device 154, the profile module 200, the content module 202, the control module 204, the transaction module 206, the extraction module 208, the profile generator 210, the segmentation module 214, the match module 216, the optimization module 222, the meta module 232, the content analyzer 234, the content generator 236, the revenue module 238, the payment module 240, and/or the notification module 244 may be enabled using a targeting circuit, a sender circuit, an individual circuit, an organization circuit, a group circuit, a recipient circuit, an individual circuit, an organization circuit, an action circuit, a tracking circuit, a catalog circuit, an individual circuit, an organization circuit, a profile circuit, a content circuit, a control circuit, a transaction circuit, a extraction circuit, a profile circuit, a segmentation circuit, a match circuit, an optimization circuit, a meta circuit, a content circuit, a content circuit, a revenue circuit, a payment circuit, and/or a notification circuit.

In addition, it will be appreciated that the various operations, processes, and methods disclosed herein may be embodied in a machine-readable medium and/or a machine accessible medium compatible with a data processing system (e.g., a computer system), and may be performed in any order. Accordingly, the specification and drawings are to be regarded in an illustrative rather than a restrictive sense.

What is claimed is:

1. A method of a delivery module, comprising:
analyzing a context data describing at least one preference of a recipient to generate a content data in a communication between a sender module and a recipient module; and
providing an incentive to a sender when the recipient responds to the content data.

2. The method of claim 1 wherein the context data is at least one of a hobby data, a geographic data, an educational data, a family data, a professional data, a culinary data, a health data, a travel data, a cultural data, a business data, an entertainment data and an epoch data.

3. The method of claim 1 further comprising automatically selecting the content data using a comparative algorithm that selects from a hierarchy of matching content when the sender composes an identifier of the recipient in the communication.

4. The method of claim 3 further comprising buffering a plurality of hierarchies of matching content in the delivery module of each recipient associated with each sender.

5. The method of claim 4 further comprising generating the hierarchy of matching content based on a meta-data match between the content data and the context data.

6. The method of claim 5 wherein the meta-data match is based a neural network algorithm that associates various terms with each other based on a profile marketing data.

7. The method of claim 1 wherein the sender can select what category of content data to display for each recipient, and wherein the categories of content data is at least one of an advertisement data, a coupon data, a sweepstakes data, an educational data, a news data, a trivia data, current event data, and a special interest data.

8. The method of claim 1 wherein the communication is generated in at least one of a web-based communication system, a telecommunication system, an email client, and a corporate intranet.

9. The method of claim 8 wherein the context data is voluntarily provided to the delivery module by the sender module using a profile generator capturing preferences of various recipients associated with the sender.

10. The method of claim 1 wherein the context data is provided by a relationship network describing attributes of various parties associated with the sender.

11. The method of claim 1 wherein the incentive is a financial disbursement to at least one of the sender and the recipient when the recipient responds to the content data and a successful transaction is verified by the delivery module and the content provider.

12. The method of claim 9 further comprising processing a payment of a content provider associated with the content data when the recipient responds to the content data.

13. The method of claim 11 wherein the financial disbursement is a portion of the payment of the content provider.

14. The method of claim 11 wherein another payment of the content provider is processed based on an impression count of the content data generated in communications between various senders and recipients.

15. The method of claim 1 further comprising enabling the sender module to respond the content data when not associated in a network communicatively coupled to the delivery module.

16. The method of claim 1 in a form of a machine-readable medium embodying a set of instructions that, when executed by a machine, cause the machine to perform the method of claim 1.

17. A method of a delivery module, comprising:
analyzing a context data describing at least one preference of a recipient to generate a content data in a communication between a sender module and a recipient module; and
processing a payment of the sender module based on a relationship between the sender module and the delivery module.

18. The method of claim 17 wherein the relationship is based on an impression count of the content data generated in communications to a plurality of recipients.

19. The method of claim 17 wherein the context data includes an organizational data, a functional-role data, a title data, and a seniority data.

20. The method of claim 19 wherein a particular offering in a catalog module is provided as the content data based on the analyzing the context data.

21. The method of claim 17 further comprising automatically selecting the content data using a comparative algorithm that selects from a hierarchy of matching content when a sender composes an identifier of the recipient in the communication.

22. The method of claim 21 further comprising buffering a plurality of hierarchies of matching content in the delivery module for each recipient associated with each sender.

23. The method of claim 22 further comprising generating the hierarchy of matching content based on a meta-data match between the content data and the context data.

24. The method of claim 23 wherein the meta-data match is based a neural network algorithm that associates various terms with each other based on a profile marketing data.

25. A system, comprising:
a delivery module to analyze a context data describing at least one preference of a recipient; and
a plurality of associated devices communicatively coupled to the delivery module to apply a targeted content data generated by the delivery module during communications between the plurality of associated devices.

26. The system of claim 25 wherein the delivery module to automatically select the targeted content data using a comparative algorithm that selects from a hierarchy of matching content when a sender composes an identifier of the recipient in the communication.

27. The system of claim 26 wherein the delivery module to buffer a plurality of hierarchies of targeted content in the delivery module for each recipient associated with each sender, and wherein the delivery module to generate the hierarchy of matching content based on a meta-data match between the targeted content data and the context data.
